(19) United States
(12) Patent Application Publication
(10) Pub. No.: US 2026/0139656 A1
(43) Pub. Date: May 21, 2026

(54) Buffer for tidal stream generation apparatus

(71) Applicant: Jia-Shing Lo, Taipei (TW)

(72) Inventors: Yu-Lin Lo, Taipei (TW); Jia-Shing Lo, Taipei (TW); Wei-Lun Lo, Taipei (TW)

(73) Assignee: Jia-Shing Lo, Taipei (TW)

(21) Appl. No.: 19/452,199

(22) Filed: Jan. 16, 2026

(30) Foreign Application Priority Data
Dec. 26, 2025 (TW) 114213723

(51) Int. Cl. F03B 13/26

(52) U.S. Cl. CPC F03B 13/264

(57) ABSTRACT

A tidal stream generation apparatus includes a housing, an inlet, an outlet, a first gate at the inlet, and a second gate at the outlet; a kinetic energy collecting device including a pivotal shaft, a waves breaking board extended downward from the shaft, an impact rod extended rearward from the shaft, and a projection disposed at a rear end of the impact rod; a set of pulleys including a movable pulley, a fixed pulley, and a rope having one end secured to the rear end of the impact rod and passing over the pulleys to have the other end secured to a counterweight; a shock absorbing assembly including a support plate, a hole disposed through the support plate with the rope passing through, and biasing members facing the counterweight and disposed externally of the hole; a tidal stream generator facing the kinetic energy collecting device; and a control device.

### FIELD OF THE INVENTION

The invention relates to tidal stream generation apparatuses and more particularly to a buffer for a tidal stream generation apparatus.

### BACKGROUND OF THE INVENTION

Electricity is undoubtedly the most fundamental and indispensable energy source supporting the operation of modern human civilization, industrial production, and daily life. Looking back at Taiwan's power generation, the main power sources are nuclear power, fossil fuel-fired thermal power, and river hydropower utilizing elevation differences. However, with the rise of global environmental awareness and emphasis on sustainable development, these traditional power generation models, after long-term operation and review, have revealed significant shortcomings and technological bottlenecks that urgently need to be addressed, posing a major potential threat and challenge to the natural environment and the safety of human habitation.

Firstly, regarding nuclear power generation, its operating principle utilizes the enormous heat energy generated by nuclear fission reactions to drive generators. While it can provide extremely stable and massive base load power under normal operation, the disposal of nuclear waste, which is an inherent problem, remains a major challenge for the scientific and engineering communities. Nuclear waste contains highly radioactive materials with extremely long half-lives. It must undergo rigorous sealing and safe storage for thousands or even tens of thousands of years to ensure that its radioactivity decays to a level that does not pose a fatal threat to the natural environment, ecology, or human health. Furthermore, if a nuclear power plant experiences a major accident such as a cooling system failure or a core meltdown, the resulting catastrophic consequences of radiation leakage are incalculable and difficult to reverse. For example, the long-term land pollution, marine ecological damage, and public panic caused by the 2011 Fukushima nuclear disaster in Japan remain a lingering shadow over the development of nuclear energy by many countries.

Secondly, regarding thermal power generation, which currently accounts for the largest share, its direct damage to the Earth's atmospheric environment is particularly evident and severe. Thermal power generation requires burning large quantities of fossil fuels such as coal, oil, or natural gas to generate heat. During the combustion, massive amounts of carbon dioxide are emitted. This is not only a major culprit in the intensification of the global greenhouse effect, abnormal climate change, and sea-level rise, but also severely deteriorates regional air quality. In addition to carbon dioxide, the combustion process also releases acidic gases such as nitrogen oxides (NO) and sulfur oxides (SO), as well as particulate matter (PM2.5). These harmful substances not only pose a significant threat to human respiratory health but also contribute to acid rain and cause irreversible corrosion and damage to ecosystems such as forests and lakes. Furthermore, fossil fuels are non-renewable and finite resources. Their extraction, refining, and long-distance transportation also cause significant resource consumption and potential pollution risks to the Earth's surface and marine environment.

In addition, regarding river hydropower in Taiwan, although it is a clean energy, its development potential is inherently limited by the island's unique natural geographical conditions. Taiwan's terrain is steep, its rivers are generally short and have rapid currents, and it lacks large, flat catchment areas. Thus, suitable geographical locations for building large-scale reservoir-type hydropower stations are extremely limited. This results in a very low proportion of total hydropower generation in the country's total energy supply, making it difficult to become a major source of base load electricity. Although hydropower does not produce air pollution, the construction of dams often disrupts the natural continuity of rivers, and causes significant anthropogenic disturbances and ecological impacts on fish migration habitats, sediment transport balance, and downstream aquatic biodiversity.

Against the backdrop of the aforementioned dilemmas facing traditional energy sources, the development of green energy has become a major strategic direction for the international community and future technological development. However, current mainstream alternative energy technologies such as wind power and solar power also face many unresolved issues in applications. Taking wind power as an example, its construction often requires extremely high construction costs, and wind turbines occupy a large area of land. If installed on land, the low-frequency noise generated by the rotating blades of the huge turbines often causes long-term disturbances to the quality of life of surrounding residents and protests. If installed at sea, it faces formidable maintenance challenges. In addition, wind power is entirely dependent on the strength and direction of wind, resulting in significant instability and intermittent fluctuations in power output, and posing challenges to grid dispatch and reliability. As for solar power, it faces difficulties such as high manufacturing costs of solar panels and potential wastewater pollution during production, and there is room for improvement in photoelectric conversion efficiency. To achieve a significant amount of power generation, a solar power system must occupy a large area of land or rooftop space, and its power generation is limited to the daytime when there is sufficient sunshine. It cannot operate in the event of cloudy or rainy weather or at night, which greatly limits its applications in providing energy around the clock.

In contrast, tidal stream generation, as an emerging marine renewable energy technology, utilizes the kinetic energy of the continuous undulation of ocean waves to convert it into electricity, and has enormous development potential. However, the nature of waves is an irregular and pulsating dynamic load, it fluctuates significantly with changes in sea conditions, tides, seasons, and wind direction, which often leads to numerous difficulties in the operation of wave energy harvesting devices.

In detail, firstly, the alternation of peaks and troughs causes the reciprocating mechanism to be subjected to repeated forces, which can easily lead to fatigue damage and loosening.

Secondly, in pursuit of energy extraction efficiency, mechanical amplification and reset structures such as levers, pulleys, gears, and counterweights are often introduced. While this can improve the flexibility of stroke and torque configuration, it also introduces more friction interfaces and impact points, which generates noise and causes instantaneous vibration at the end of the stroke.

Thirdly, the salt spray corrosion and biofouling problems in the seawater environment increase the maintenance costs of bearings, ropes, pulleys and guide components.

Fourthly, if the recovery mechanism relies on counterweights or elastic elements, the inertial effect can cause the components to over travel or the tension to rise instantaneously when the waves impact or the wave height increases suddenly, resulting in rope pulling, uneven load on pulleys, and even structural interference and damage.

There is a conventional tidal stream generation apparatus. It uses a relatively simple housing and lever energy collecting mechanism, combined with a pulley and counterweight return mechanism, to convert the impact kinetic energy of waves into mechanical energy usable by the power generation apparatus. It achieves continuous reciprocating motion through the counterweight return mechanism. The apparatus comprises a housing, a kinetic energy collector of tidal stream, a pulley system, and a power generation device. Its operating principle is as follows: when waves impact the wave impact plate through the inlet, the kinetic energy collector of tidal stream is driven to rotate about the support shaft, causes the impact rod to pull the rope through the pulley system and vertically lifts the counterweight. The power generation device receives the kinetic energy from the impact rod to generate electricity. When the waves recede, the counterweight descends due to gravity, and the reverse traction mechanism returns it to its initial state, thereby forming a continuous reciprocating power generation cycle.

However, even though the apparatus can achieve recovery and reset with the counterweight and improve the feasibility of continuous operation, there are still areas for improvement under actual sea conditions.

In detail, firstly, the impact of ocean waves has an instantaneous peak value. Due to the leverage amplification relationship, the impact rod may generate a high speed of motion in a short period of time, which in turn causes the rope to quickly pull the counterweight upward. When the counterweight reaches the end of its stroke, if there is a lack of proper energy absorption and cushioning design, the counterweight may collide or make hard contact at the end of its upward stroke due to inertia, generating instantaneous noise and vibration. It may also cause a sudden increase in the tension of the rope and form an impact load on the first fastened pulley, the second fastened pulley, and their connecting rods.

Secondly, this rigid impact lacking a buffer mechanism will lead to a series of serious negative consequences: the violent collision between the metal counterweight and the block and tackle will generate great noise, which in turn generate great noise in the tranquil coastal environment, Further, the repeated and high-intensity impact force will be directly transmitted to the bearings, support rods, and connection points of the rope of the pulley, causing stress concentration, deformation or even breakage of related mechanical parts and significantly shortening the service life and durability of the apparatus. Furthermore, the violent impact vibration may affect the operational stability of the precision electronic components in the power generation apparatus and control, thereby reducing the overall power generation efficiency and reliability.

Thirdly, if the rope breaks due to excessive tensile force from the instantaneous impact, it may cause the counterweight to fall out of control, resulting in serious damage to the bottom of the box. For tidal stream generation apparatuses that aim for long-term stable operation, this is a structural defect that must be solved immediately.

### SUMMARY OF THE INVENTION

It is therefore one object of the invention to provide a generating apparatus for converting kinetic energy from a water flow to electrical energy comprising a housing comprising a front plate, a rear plate, two side plates, a top plate, a bottom plate, an inlet disposed through the front plate for flowing sea water into the housing, an outlet disposed through the rear plate for flowing sea water out of the housing, a first gate disposed at the inlet, a first activation device disposed at the inlet for opening or closing the first gate, a second gate disposed at the outlet, and a second activation device disposed at the outlet for opening or closing the second gate; a kinetic energy collecting device disposed in the housing and comprising a shaft, two pivots at two ends of the shaft pivotably secured to the side plates respectively, a waves breaking board extended downward from the shaft to dispose between the inlet and the outlet, an impact rod extended rearward from the shaft, and a projection disposed at a rear end of the impact rod wherein length of the impact rod is greater than height of the waves breaking board; a set of pulleys disposed in the housing and comprising a first connecting rod having two ends fastened in the side plates respectively, a movable pulley disposed on an intermediate portion of the first connecting rod, a second connecting rod having two ends fastened in the side plates respectively, a fixed pulley disposed on an intermediate portion of the second connecting rod, a rope having a first end secured to the rear end of the impact rod, the rope passing over the movable pulley and the fixed pulley to have a second end secured to a counterweight, and a guide tube with the counterweight movably disposed therein; a shock absorbing assembly disposed under the fixed pulley and above the counterweight, the shock absorbing assembly comprising a support plate having two ends secured to the side plates respectively, a hole disposed through the support plate with the rope passing through, and a plurality of biasing members facing the counterweight and disposed externally of the hole; a tidal stream generator comprising an energy storage device disposed on the front plate, an electricity generation device disposed on the energy storage device and facing the kinetic energy collecting device, and an elastic member disposed on the electricity generation device; and a control device disposed on the front plate and comprising a rechargeable battery electrically connected to the tidal stream generator and configured to store electricity, a wireless receiver electrically connected to the rechargeable battery, and a water level sensor electrically connected to the rechargeable battery.

The above and other objects, features and advantages of the invention will become apparent from the following detailed description taken with the accompanying drawings.

### BRIEF DESCRIPTION OF THE DRAWINGS

FIG. 1 is an exploded view of a tidal stream generation apparatus having a buffer according to a preferred embodiment of the invention;

FIG. 2 is a perspective view of the kinetic energy collecting device;

FIG. 3 is a perspective view of the set of pulleys with the support plate shown in broken lines;

FIG. 4 is an exploded, perspective view of the buffer being partly assembled with the support plate shown in broken lines;

FIG. 5 schematically depicts movements of the first gate and the second gate in a housing shown in broke lines;

FIG. 6 schematically depicts a movement of the kinetic energy collecting device in the housing;

FIG. 7 schematically depicts a movement of the kinetic energy collecting device and the set of pulleys in FIG. 6;

FIG. 8 is a side elevation of FIG. 6;

FIG. 9 is a side elevation of FIG. 6 showing a second embodiment of the set of pulleys;

FIG. 10 schematically depicts a movement of the kinetic energy collecting device and the set of pulleys in FIG. 9 in response to waves striking;

FIG. 11 is a perspective view of the buffer having legs mounted thereunder; and

FIG. 12 is a block diagram of the tidal stream generation apparatus.

### DETAILED DESCRIPTION OF THE INVENTION

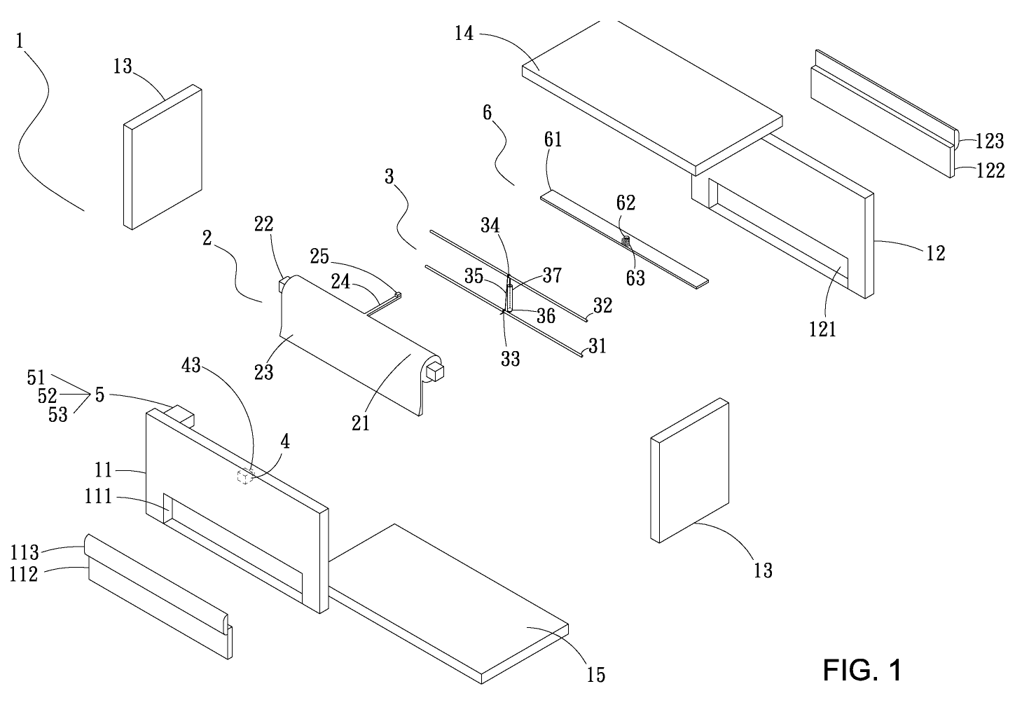

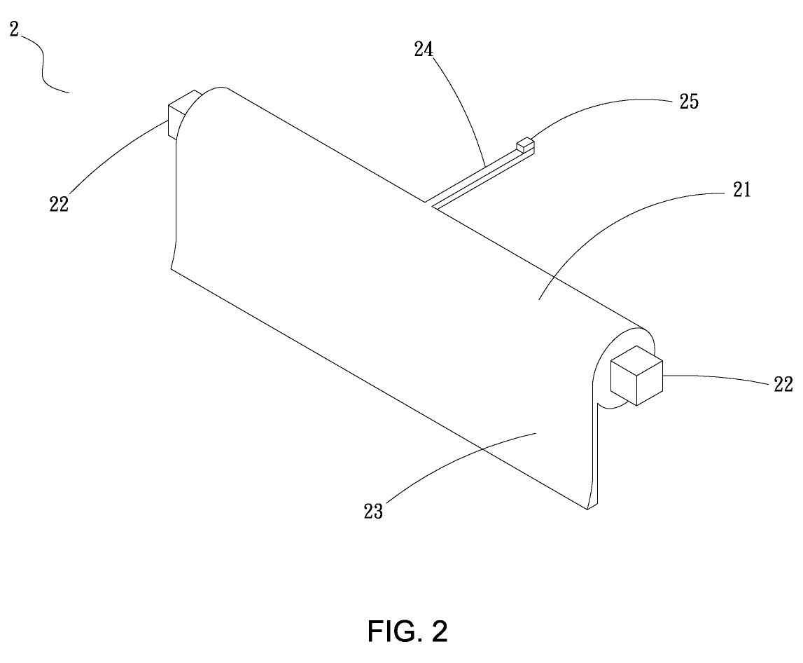

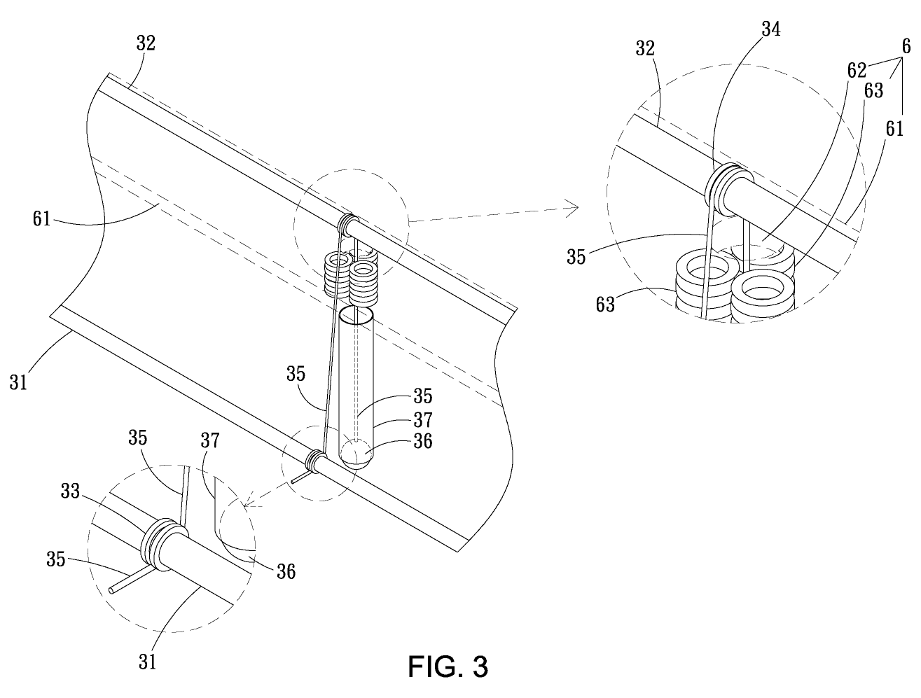

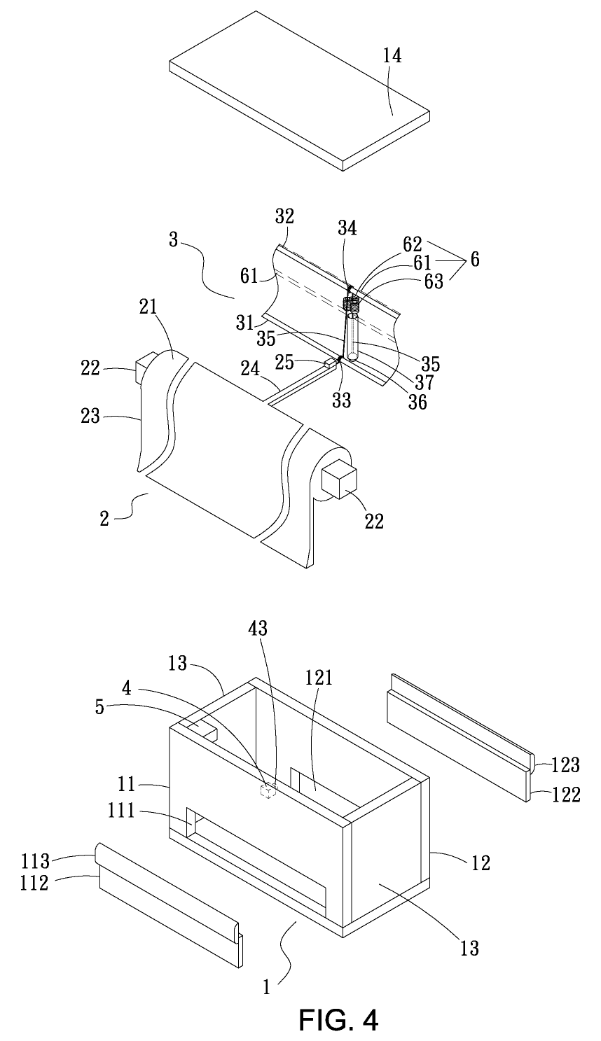

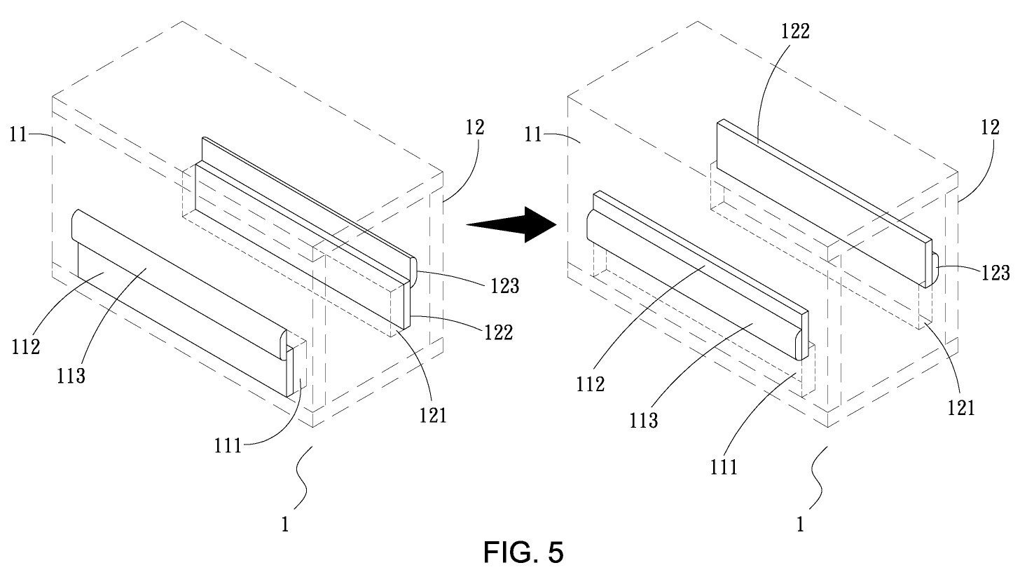

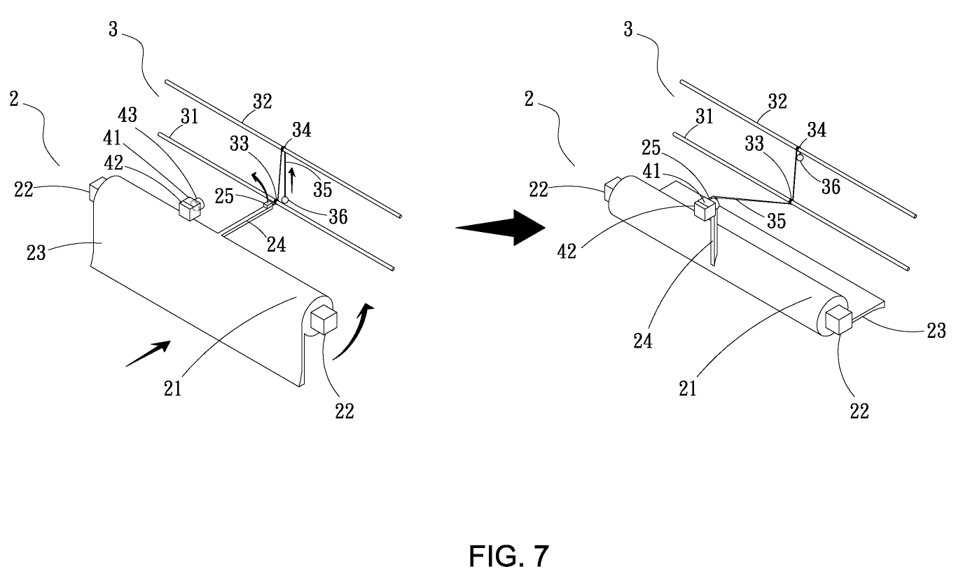

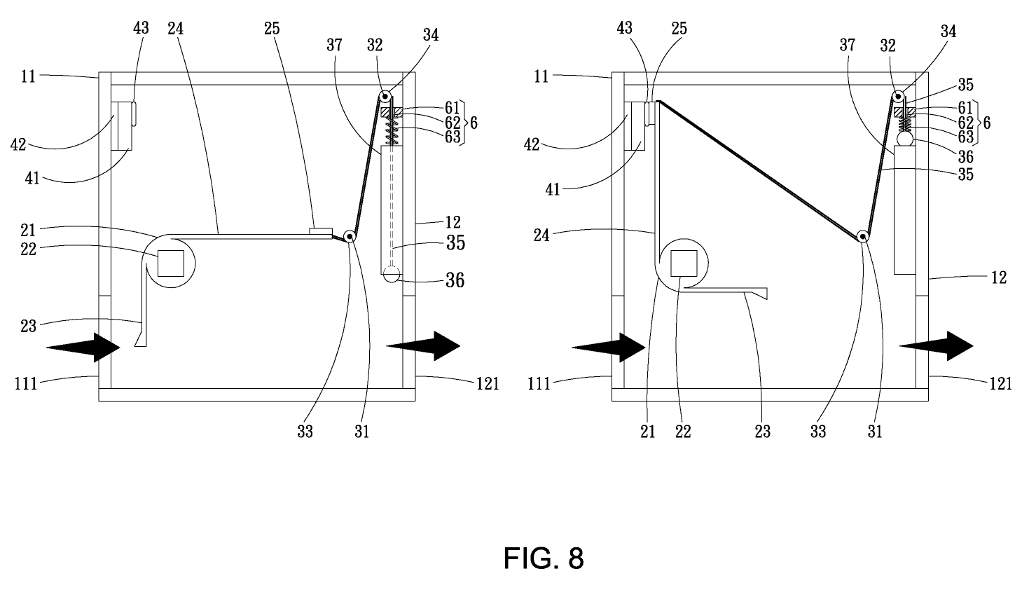

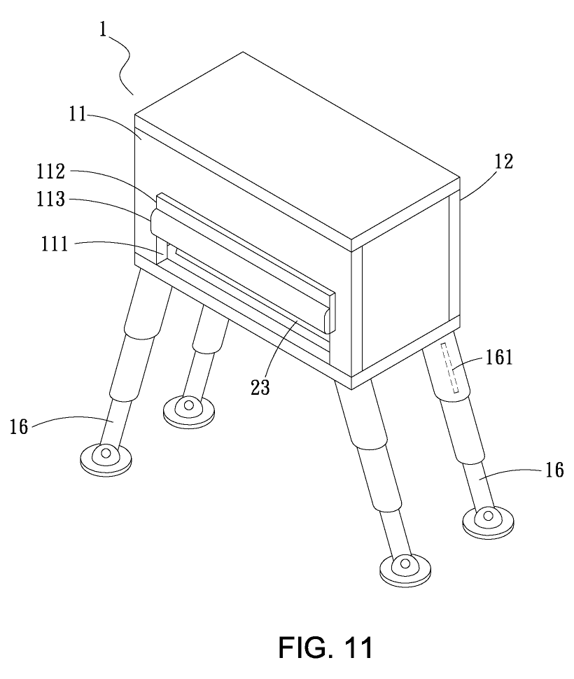

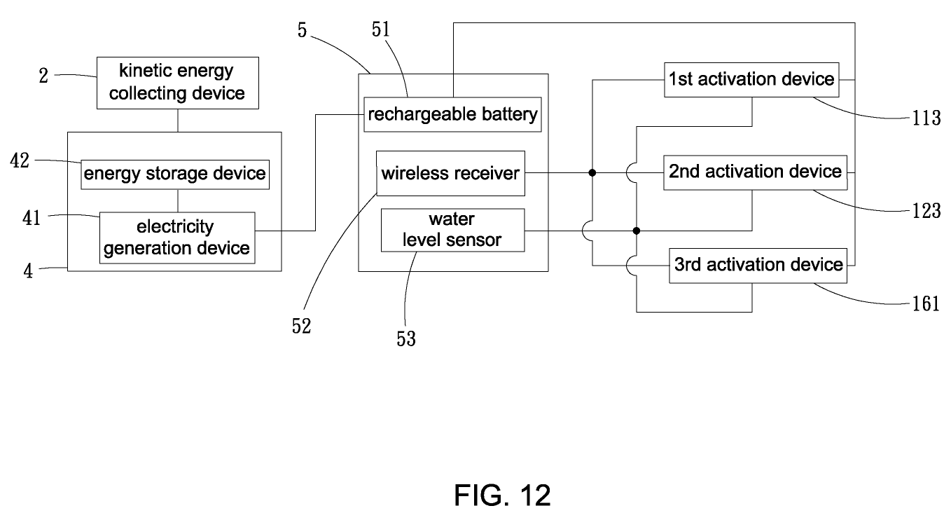

Referring to FIGS. 1 to 8, 11, and 12, a tidal stream generation apparatus in accordance with a preferred embodiment of the invention comprises a housing 1, a kinetic energy collecting device 2, a set of pulleys 3, a tidal stream generator 4, a control device 5, and a shock absorbing assembly 6 as discussed in detail below.

Kinetic energy of waves entering the housing 1 is collected by the kinetic energy collecting device 2 to pivot an impact rod 24 so that an electricity generation device 41 may generate electricity which is supplied to an energy storage device 42 for storage. In the other aspect, a rope 35 may be pulled to activate the set of pulleys 3 so as to lift or lower a counterweight 36 as means of returning. The shock absorbing assembly 6 is located at an end of an upward movement of the counterweight 36 for absorbing impact of the upward moving counterweight 36. As a result, both noise and vibration are decreased as well as load decrease on each of the rope 35, a first connecting rod 31 having two ends fastened in the side plates 13 respectively, a movable pulley 33 disposed on a center of the first connecting rod 31, a second connecting rod 32 having two ends fastened in the side plates 13 respectively, and a fixed pulley 34 disposed on a center of the second connecting rod 32.

The parallelepiped housing 1 comprises a front plate 11, a rear plate 12, two side plates 13, a top plate 14, and a bottom plate 15. An inlet 111 for flowing sea water in is disposed through the front plate 11. An outlet 121 for flowing seat water out is disposed through the rear plate 12. A flow path from the inlet 111 to the outlet 121 is formed. A first gate 112 and a first activation device 113 are disposed at the inlet 111. A second gate 122 and a second activation device 123 are disposed at the outlet 121. The first activation device 113 is used to receive control signals and activates to open or close the first gate 112 and the second activation device 123 is used to receive control signals and activates to open or close the second gate 122 respectively. The first and second gates 112, 122 may be closed when sea is rough for protecting internal members of the housing 1 or for maintenance. Moreover, the amount of sea water entering the housing 1 can be controlled (i.e., adjusted) by opening the first and second gates 112, 122 to a desired extent. As a result, force impinging a waves breaking board 23 can be controlled to an optimum. A plurality of legs 16 are provided on an underside of the housing 1. A third activation device 161 is provided in each leg 16 for receiving control signals and activates to extend or contract its corresponding leg 16 in response. As a result, height of the housing 1 installed on the seabed can be adjusted to be adapted to rising or falling tide.

The kinetic energy collecting device 2 is disposed in the housing 1 and comprises a shaft 21, two pivots 22 at two ends of the shaft 21 pivotably secured to the side plates 13 respectively. The shaft 21 is configured to rotate about the side plates 12. Thus, the kinetic energy collecting device 2 may turn back and forth repeatedly. The waves breaking board 23 is extended downward from the shaft 21. The impact rod 24 is extended rearward from the shaft 21. The waves breaking board 23 is adjacent to the inlet 111 and disposed rearward of the inlet 111 so that waves may impinge the waves breaking board 23 to produce a torque after entering the inlet 111. A projection 25 is provided at a rear end of the impact rod 24 for effectively transmitting kinetic energy to the electricity generation device 41 for generating electricity which is supplied to the energy storage device 42 for storage. Length of the impact rod 24 is greater than height of the waves breaking board 23. The impact rod 24 may strike the electricity generation device 41 in high speed after the waves breaking board 23 has been pivoted by the waves.

The set of pulleys 3 is disposed in the housing 1 and comprises the first connecting rod 31 secured to one side plate 31, the second connecting rod 32 secured to the other side plate 31, the movable pulley 33 provided on the center of the first connecting rod 31, the fixed pulley 34 provided on the center of the second connecting rod 32, a rope 35 having one end secured to the end of the impact rod 24 and passing over the movable pulley 33 and the fixed pulley 34 to have the other end thereof secured to a counterweight 36. A vertical position of the counterweight 36 may be changed in response to a pivotal movement of the impact rod 24. In brief, the counterweight 36 may rise after the waves breaking board 23 has been impinged by the waves and next a 90-degree pivotal movement of the impact rod 24. Subsequently, the counterweight 36 may fall to its inoperative position after the waves have lost its kinetic energy and next a 90-degree pivotal movement of the impact rod 24 in an opposite direction. This completes a reciprocating power generation cycle. The set of pulleys 3 further comprises a guide tube 37 with the counterweight 36 disposed therein. The counterweight 36 is configured to strictly move vertically in the guide tube 37 with deviation being avoided. As a result, the stability of the rope 35, the movable pulley 33, and the fixed pulley 34 in operation is greatly increased.

The shock absorbing assembly 6 is provided under the fixed pulley 34 and above the counterweight 36. The shock absorbing assembly 6 comprises a support plate 61 having two ends secured to the side plates 13 respectively, a hole 62 disposed through an intermediate portion of the support plate 61 with the rope 35 passing through, and a plurality of resilient members 63 facing the counterweight 36 and disposed externally of the hole 62. In the embodiment, the resilient members 63 are torsion springs. The resilient members 63 are used to absorb force exerted on the counterweight 36 when they contact each other, thereby preventing the counterweight 36 from striking the support plate 61. As a result, the operation is made smooth.

The tidal stream generator 4 comprises the energy storage device 42 disposed on the front plate 11, and the electricity generation device 41 disposed on the energy storage device 42 and facing the kinetic energy collecting device 2. In response to the waves breaking board 23 being impinged by the waves, the projection 25 strikes the electricity generation device 41 which converts the striking force into electricity. The electricity generation device 41 supplies the electricity to the energy storage device 42 for storage. The energy storage device 42 is implemented as a hydraulic energy storage device, a pneumatic energy storage device, or the like. Thus, the electricity generation device 41 may extract energy from the waves to generate electricity. An elastic member 43 is provided on the electricity generation device 41 for further returning the impact rod 24 to its inoperative position after the strike.

The control device 5 is disposed on the front plate 11 and comprises a rechargeable battery 51 electrically connected to the tidal stream generator 4 and adapted to supply power to other electrical components, a wireless receiver 52 for receiving signals from an external signal source, and a water level sensor 53 for sensing water level and generating a control signal in response, the control signal being used to adjust height of each leg 16 and opening or closing the first gate 112 and the second gate 122. Specifically, the control device 5 may adjust heights of the legs 16 in response to sea level sensed by the water level sensor 53 so that a relative position of the inlet 111 and the waves breaking board 23 can be kept to an optimum. Further, the control device 5 may close both the first gate 112 and the second gate 122 when sea is rough. As a result, the components inside the housing 1 is protected.

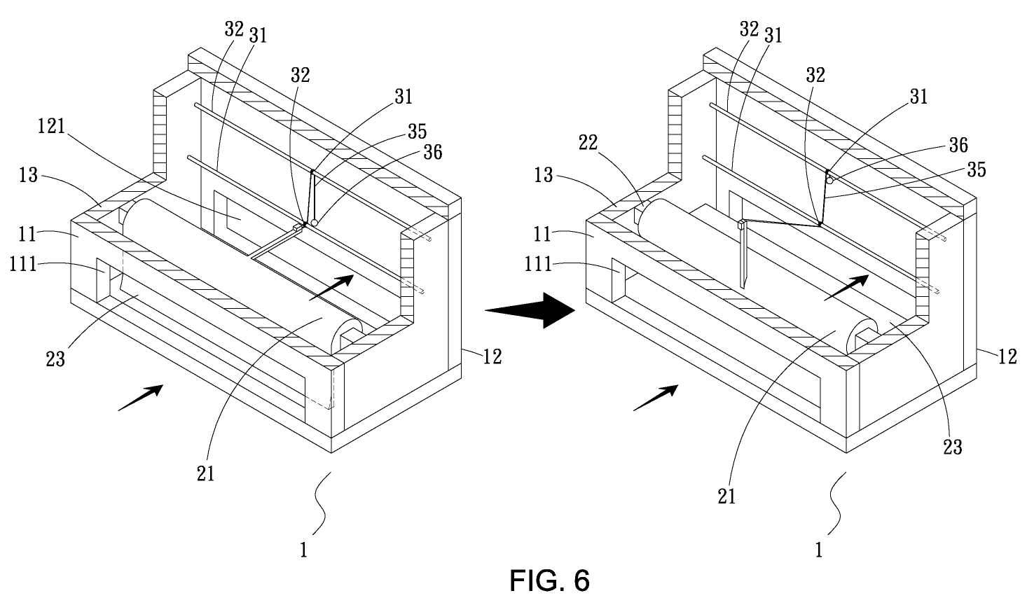

As shown in FIGS. 6 to 8 specifically, after the waves enter the inlet 111 and impinge the waves breaking board 23, the waves breaking board 23 may rotate about the shaft 21 to pivot the horizontally disposed impact rod 24 to dispose vertically. And in turn, the projection 25 strikes the electricity generation device 41. Also, the rope 35 is pulled to pass over the movable pulley 33 and the fixed pulley 34. And in turn, the counterweight 36 rises. Shock generated by the upward movement of the counterweight 36 is absorbed by the compressed resilient members 63. After the striking force on the waves breaking board 23 disappears, the counterweight 36 may fall due to gravity and an elastic expansion of the compressed buffer members 63. And in turn, the rope 35 is pulled in an opposite direction to return both the impact rod 24 and the waves breaking board 23 to their inoperative positions. This finishes the reciprocating power generation cycle.

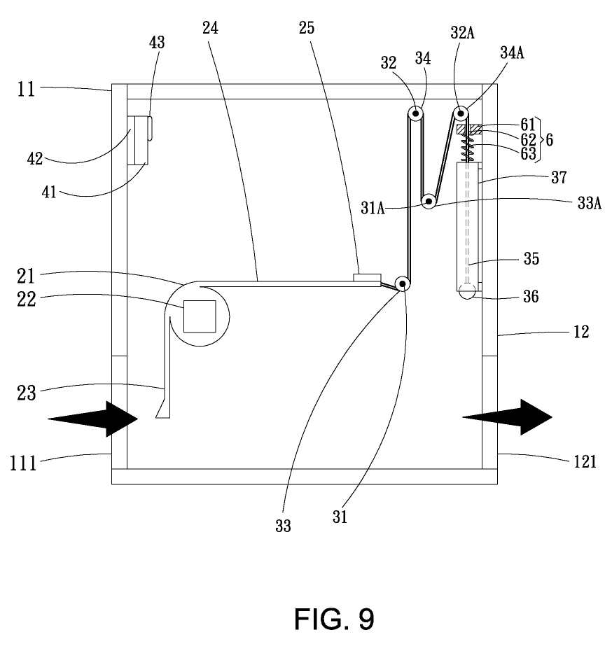

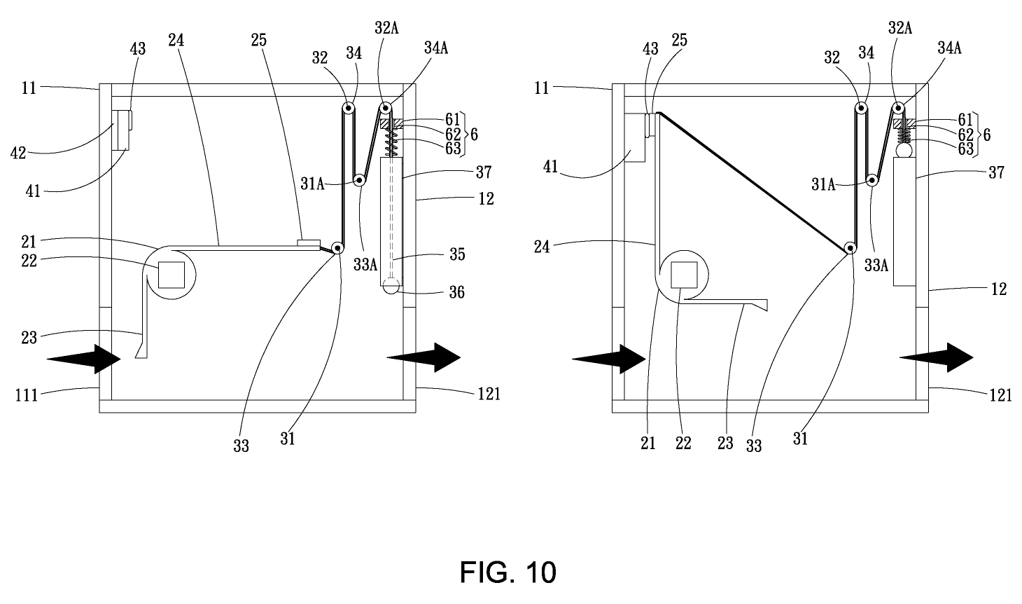

Referring to FIGS. 9 and 10, a second embodiment of the set of pulleys 3 is shown. The set of pulleys 3 further comprises a second movable pulley 33A and a corresponding third connecting rod 31A; and a second fixed pulley 34A and a corresponding fourth connecting rod 32A. The rope 35 passes over the movable pulley 33, the fixed pulley 34, the second movable pulley 33A, and the second fixed pulley 34A in sequence. This embodiment further decreases a pulling force of the rope 35 in the power generation cycle.

While the invention has been described in terms of preferred embodiments, those skilled in the art will recognize that the invention can be practiced with modifications within the spirit and scope of the appended claims.

What is claimed is:

1. A generating apparatus for converting kinetic energy from a water flow to electrical energy, comprising:
a housing comprising a front plate, a rear plate, two side plates, a top plate, a bottom plate, an inlet disposed through the front plate for flowing sea water into the housing, an outlet disposed through the rear plate for flowing sea water out of the housing, a first gate disposed at the inlet, a first activation device disposed at the inlet for opening or closing the first gate, a second gate disposed at the outlet, and a second activation device disposed at the outlet for opening or closing the second gate;
a kinetic energy collecting device disposed in the housing and comprising a shaft, two pivots at two ends of the shaft pivotably secured to the side plates respectively, a waves breaking board extended downward from the shaft to dispose between the inlet and the outlet, an impact rod extended rearward from the shaft, and a projection disposed at a rear end of the impact rod wherein length of the impact rod is greater than height of the waves breaking board;
a set of pulleys disposed in the housing and comprising a first connecting rod having two ends fastened in the side plates respectively, a movable pulley disposed on an intermediate portion of the first connecting rod, a second connecting rod having two ends fastened in the side plates respectively, a fixed pulley disposed on an intermediate portion of the second connecting rod, a rope having a first end secured to the rear end of the impact rod, the rope passing over the movable pulley and the fixed pulley to have a second end secured to a counterweight, and a guide tube with the counterweight movably disposed therein;
a shock absorbing assembly disposed under the fixed pulley and above the counterweight, the shock absorbing assembly comprising a support plate having two ends secured to the side plates respectively, a hole disposed through the support plate with the rope passing through, and a plurality of biasing members facing the counterweight and disposed externally of the hole;
a tidal stream generator comprising an energy storage device disposed on the front plate, an electricity generation device disposed on the energy storage device and facing the kinetic energy collecting device, and an elastic member disposed on the electricity generation device; and
a control device disposed on the front plate and comprising a rechargeable battery electrically connected to the tidal stream generator and configured to store electricity, a wireless receiver electrically connected to the rechargeable battery, and a water level sensor electrically connected to the rechargeable battery.
